(19) United States
(12) Patent Application Publication
(10) Pub. No.: US 2025/0377572 A1
(43) Pub. Date: Dec. 11, 2025

(54) ELECTROPHORETIC DISPLAY PANEL, DRIVING METHOD THEREOF, AND DISPLAY DEVICE

(71) Applicant: Shanghai Tianma Microelectronics Co., Ltd., Shanghai (CN)

(72) Inventor: Wanlong Guo, Shanghai (CN)

(73) Assignee: Shanghai Tianma Microelectronics Co., Ltd., Shanghai (CN)

(21) Appl. No.: 19/302,237

(22) Filed: Aug. 18, 2025

(30) Foreign Application Priority Data
Nov. 25, 2024 (CN) 202411705864.3

(51) Int. Cl. G02F 1/1685; G02F 1/167; G09G 3/34

(52) U.S. Cl. CPC G02F 1/1685; G02F 1/167; G09G 3/344; G09G 2310/068; G09G 2320/0233

(57) ABSTRACT

Provided denotes an electrophoretic display panel, a driving method of the electrophoretic display panel, and a display device. The electrophoretic display panel includes a data lines and a pixels, the data lines is configured to transmit a data signal to the pixels, and the data signal includes multiple unit periods. In a driving stage, in an i-th unit period tᵢ, a unit driving voltage of the data signal is Vᵢ, a target effective drive is Vₘ, and Vₘ=ΣVᵢtᵢ is satisfied, where i is a positive integer. A theoretical effective drive satisfies at least one of following equations: in an equation (1), when a target gray scale is fixed,

$${V}_{l} = \frac{64}{n} A x + B ,$$

where 0.23<A<0.29, and −20<B<10; in an equation (2), when an initial gray scale is fixed,

$${V}_{l} = \frac{64}{n} C y + D ,$$

where −0.22<C<−0.10, and 0<D<25.

### CROSS-REFERENCE TO RELATED APPLICATION

This application claims priority to Chinese Patent Application No. 202411705864.3 filed Nov. 25, 2024, the disclosure of which is incorporated herein by reference in its entirety.

### TECHNICAL FIELD

The present disclosure relates to the field of display technologies, and in particularly, to an electrophoretic display panel, a driving method of the electrophoretic display panel, and a display device.

### BACKGROUND

Electronic paper (E-Paper) is a type of a display screen in which the electronic ink is coated on the thin film, the thin film is attached to the thin film transistor circuit, and the pixel pattern is formed through driving. The electronic paper has the advantages of energy saving, protecting eyes and keeping display even after being powered off, and the electronic paper may simulate the visual perception of printing and writing on the paper. The principle of the electronic paper is to use the electrophoresis of charged particles, that is, two anisotropic charged particles move to the two electrodes of the display under the driving of the electric field, so that one side of the transparent electrode displays the color of one charged particle.

At present, a gray scale of the electronic paper is generally controlled by adopting the pulse width modulation (PWM) mode. However, the temperature problem, the historical problem and the nonlinear problem caused by the driving of the electronic paper cause that the driving duration of the electronic paper is not in a simple linear relationship with the gray scale of the electronic paper, and thus, the rapid and accurate adjustment of the gray scale is very difficult.

### SUMMARY

Based on the above-described problems, the present disclosure provides an electrophoretic display panel, a driving method of the electrophoretic display panel, and a display device, where an effective drive of a required driving waveform is calculated according to at least one formula, an initial gray scale and a target gray scale, and the gray scale is further adjusted according to the driving waveform, whereby the speed and the accuracy of adjustment of the gray scale are improved.

In a first aspect, an embodiment of the present disclosure provides an electrophoretic display panel. The electrophoretic display panel includes a data line and a pixel, where the data line is configured to transmit a data signal to the pixel, and the data signal includes multiple unit periods. In a driving stage of the electrophoretic display panel, in an i-th unit period tᵢ among the multiple unit periods, a unit driving voltage of the data signal is Vᵢ, a target effective drive is Vₘ, and Vₘ=ΣVᵢtᵢ is satisfied, where i is a positive integer. A theoretical effective drive satisfies at least one of following equations. In an equation (1), when a target gray scale is fixed,

$${V}_{l} = \frac{64}{n} Ax + B ;$$

where x denotes an initial gray scale, y denotes the target gray scale, Vₗ denotes the theoretical effective drive, each of x and y denotes an integer, and n is a number of gray scales of the electrophoretic display panel in one driving mode, and where 0.23<A<0.29, −20<B<10. In an equation (2), when the initial gray scale is fixed,

$${V}_{l} = \frac{64}{n} Cy + D ;$$

where −0.22<C<−0.10, 0<D<25. A difference value between the target effective drive and the theoretical effective drive is less than or equal to 5.

Based on the same inventive concept, in a second aspect, an embodiment of the present disclosure provides a display device including the electrophoretic display panel described in the first aspect.

Based on the same inventive concept, in a third aspect, an embodiment of the present disclosure provides a driving method of an electrophoretic display panel, including the electrophoretic display panel described in the first aspect.

In the electrophoretic display panel provided in the embodiments of the present disclosure, in the driving stage of the electrophoretic display panel, in the i-th unit period tᵢ, the unit driving voltage of the data signal is V, the target effective drive is Vₘ, Vₘ=ΣVᵢtᵢ is satisfied, that is, the target effective drive is the accumulation sum of the unit driving voltage and time in the unit period. Furthermore, the theoretical effective drive satisfies at least one of the following equations: when the target gray scale is fixed,

$${V}_{l} = \frac{64}{n} Ax + B$$

is satisfied, where 0.23<A<0.29, and −20<B<10; when the initial gray scale is fixed,

$${V}_{l} = \frac{64}{n} Cy + D$$

is satisfied, where −0.22<C<−0.10, and 0<D<25, where x is the initial gray scale, y denotes the target gray scale, Vₗ denotes the theoretical effective drive, and n is a number of gray scales of the electrophoretic display panel in one driving mode. The difference value between the target effective drive and the theoretical effective drive is relatively small, and the rule satisfied by each numerical point of the target effective drive may be described by using the equation satisfied by the theoretical effective drive. The driving waveform determined according to the target effective drive is relatively accurate. Moreover, during debugging, a value of the theoretical effective drive is obtained according to the equation (1) and/or the equation (2), a test is performed near the value of the theoretical effective drive based on the value of the theoretical effective drive, and a suitable value of the effective drive is found as the target effective drive. Compared with blind debugging without any basis, the speed and accuracy of adjustment of the gray scale are improved, and thus the calibration difficulty of the gray scale in the process of testing the electrophoretic display panel can be reduced.

### BRIEF DESCRIPTION OF THE DRAWINGS

FIG. 1 is a top view of an electrophoretic display panel according to an embodiment of the present disclosure;

FIG. 2 is a sectional view of an electrophoretic display panel according to an embodiment of the present disclosure;

FIG. 3 is a drive timing graph of an electrophoretic display panel according to an embodiment of the present disclosure;

FIG. 4 is a schematic diagram of a relationship between an initial gray scale and an effective drive according to an embodiment of the present disclosure;

FIG. 5 is a schematic diagram of a relationship between an initial gray scale and an effective drive according to an embodiment of the present disclosure;

FIG. 6 is a schematic diagram of another relationship between a target gray scale and an effective drive according to an embodiment of the present disclosure;

FIG. 7 is a drive timing graph of another electrophoretic display panel according to an embodiment of the present disclosure;

FIG. 8 is a drive timing graph of another electrophoretic display panel according to an embodiment of the present disclosure;

FIG. 9 is a drive timing graph of another electrophoretic display panel according to an embodiment of the present disclosure;

FIG. 10 is a sectional view of another electrophoretic display panel according to an embodiment of the present disclosure;

FIG. 11 is a sectional view of another electrophoretic display panel according to an embodiment of the present disclosure;

FIG. 12 is a top view of a display device according to an embodiment of the present disclosure;

FIG. 13 is a flowchart of a driving method of an electrophoretic display panel according to an embodiment of the present disclosure; and

FIG. 14 is a flowchart of another driving method of an electrophoretic display panel according to an embodiment of the present disclosure.

### DETAILED DESCRIPTION

The present disclosure will be further described in detail in conjunction with the drawings and embodiments below. It is to be understood that the specific embodiments described herein are merely used for explaining the present disclosure and are not intended to limit the present disclosure. It is also to be noted that, for ease of description, only some, but not all, of the structures related to the present disclosure are shown in the drawings.

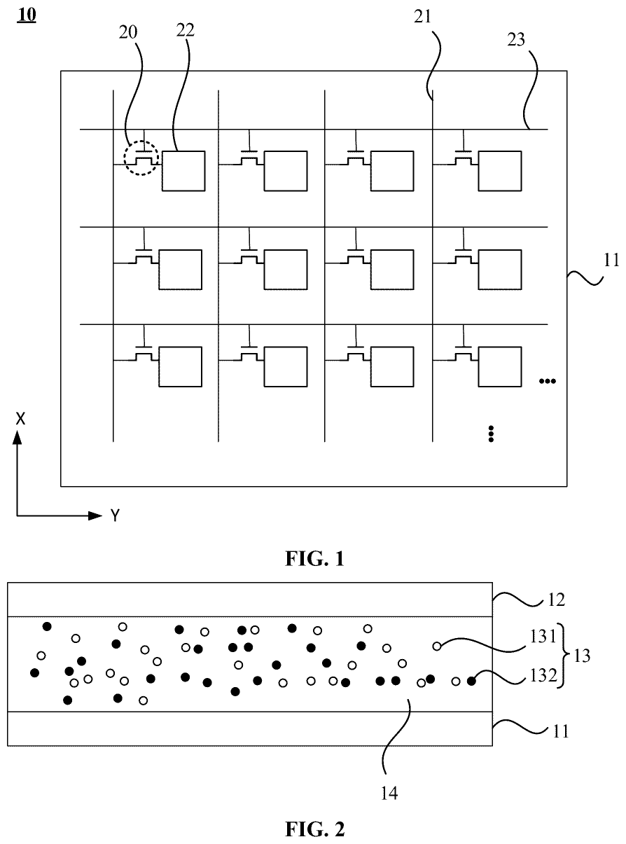

FIG. 1 is a top view of an electrophoretic display panel according to an embodiment of the present disclosure. Referring to FIG. 1, the electrophoretic display panel 10 includes a data line 21 and a pixel 22, and the data line 21 is configured to transmit a data signal to the pixel 22. Multiple data lines 21 extend in a first direction X and are arranged in a second direction Y The first direction X intersects the second direction Y Further, the electrophoretic display panel 10 further includes a scanning line 23 configured to transmit a scanning signal to the pixel 22, and the scanning signal is a signal for controlling a thin film transistor 20 to be turned on. Multiple scanning lines 23 extend in the second direction Y and are arranged in the first direction X. When the thin film transistor 20 is turned on, the data signal is written to the pixel 22. The electrophoretic display panel 10 may display a particular image by writing different data signals into different pixels 22.

FIG. 2 is a sectional view of an electrophoretic display panel according to an embodiment of the present disclosure. Referring to FIG. 2, the electrophoretic display panel 10 includes a first substrate 11, a second substrate 12 and electrophoretic particles 13. The first substrate 11 and the second substrate 12 are disposed opposite to each other, and the electrophoretic particles 13 are located between the first substrate 11 and the second substrate 12. The data line 21, the pixel 22 and the scanning line 23 in the electrophoretic display panel 10 may be located on the same side of the first substrate 11 facing the electrophoretic particles 13. That is, the data line 21, the pixel 22 and the scanning line 23 are disposed on the first substrate 11, and the electrophoretic particles 13 are disposed on one side, provided with the data line 21, the pixel 22 and the scanning line 23, of the first substrate 11. Optionally, the electrophoretic particles 13 may include a black electrophoretic particle and a white electrophoretic particle. Under the action of an electric field, when the black electrophoretic particle is located on a display side of the electrophoretic display panel (such as, a side of the second substrate 12 facing away from the first substrate 11), light is absorbed by the black electrophoretic particle, so that less light is reflected to human eyes, and a dark region is viewed by the human eyes, for example, a value of a gray scale is recorded as 0. When the white electrophoretic particle is located on the display side of the electrophoretic display panel, light is reflected by the white electrophoretic particle, so that more light is reflected to the human eyes, and a bright region is viewed by the human eyes, for example, a value of a gray scale is recorded as 63 or 15. When the black electrophoretic particle and the white electrophoretic particle are located between the second substrate 12 and the first substrate 11, part of light is reflected and part of light is absorbed, a gray region is viewed by the human eyes, and a value of a gray scale is recorded as between 0 and 64 or between 0 and 15. The embodiments of the present disclosure may be explained by using a dual-particle system, but are not limited thereto.

FIG. 3 is a drive timing graph of an electrophoretic display panel according to an embodiment of the present disclosure. Referring to FIG. 1 and FIG. 3, the data signal Source includes multiple unit periods P0. A duration of an enable level of the data signal Source is an integer multiple of the unit period P0. In a driving stage of the electrophoretic display panel 10, the multiple data lines 21 write different data signals Source for different pixels 22, so that the different pixels 22 may have different display brightness, and the different pixels 22 may have different gray scales. Due to the influence of different parameters in the electrophoretic display panel 10, the gray scale of the pixel 22 has a non-linear relationship with the driving duration in the electrophoretic display panel 10, whereby it is difficult to adjust the gray scale according to the display requirement. For example, the parameter may be a temperature factor of the electrophoretic display panel 10 and a display influence of a previous picture and the like, which is not specifically limited in the embodiments of the present disclosure.

In the driving stage, in an i-th unit period tᵢ, a unit driving voltage of the data signal Source is Vᵢ, and a target effective drive is Vₘ, whereby the target effective drive is expressed as: Vₘ=ΣVᵢtᵢ, where i is a positive integer. A length of the i-th unit period t, is equal to a length of the unit period P0. In one embodiment, a duration of the unit period P0 is a duration of a scanning frame. Referring to FIG. 1, in one scanning frame, the scanning is performed row by row from a first scanning line 23 to a last scanning line 23. The unit driving voltage Vᵢ is a driving voltage after a normalization processing is performed. A voltage value of an i-th unit driving voltage Vᵢ is 1V The target effective drive Vₘ represents an accumulated value of a product of voltage and time. The target effective drive may be understood as a value of an effective drive actually applied.

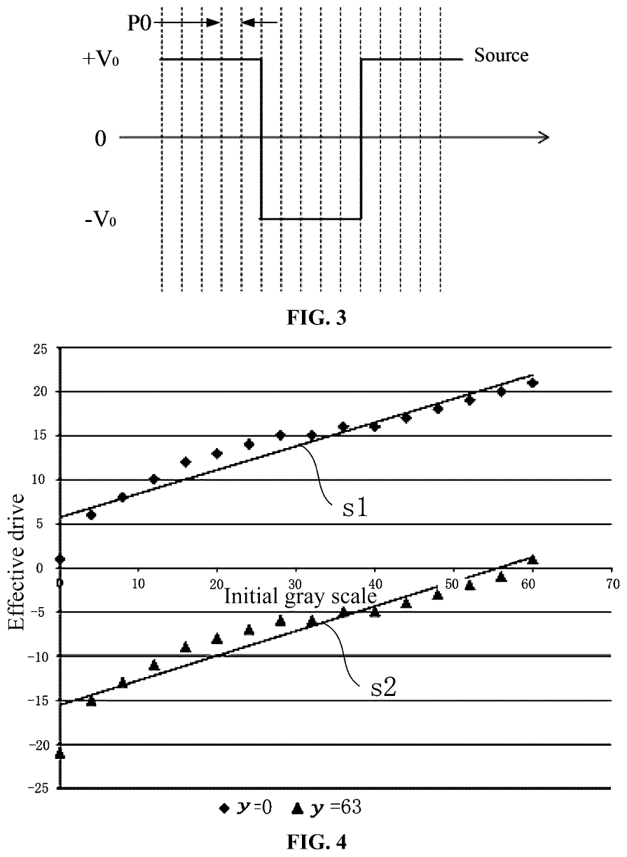

FIG. 4 is a schematic diagram of a relationship between an initial gray scale and an effective drive according to an embodiment of the present disclosure. Referring to FIG. 4, a value of an abscissa in FIG. 4 represents a value of the initial gray scale, a value of an ordinate in FIG. 4 represents a value of the effective drive, and the effective drive includes the target effective drive and the theoretical effective drive. FIG. 4 shows multiple discrete points, and an effective drive corresponding to the discrete point denotes the target effective drive. The discrete point may be understood as a point determined in the coordinate system by a value of a certain initial gray scale and a value of a certain effective drive when the target gray scale is a fixed value. The initial gray scale is a gray scale value corresponding to a current picture at a starting occasion, that is, a gray scale value corresponding to a previous picture at an ending occasion. The target gray scale is a preset gray scale value. Two fitting curves (s1 and s2 shown in FIG. 4) are shown in FIG. 4, where the fitting curve is an equation that the theoretical effective drive and the initial gray scale are used as variables when the target gray scale is the fixed value, and the effective drive that may be obtained by substituting the initial gray scale into the equation denotes the theoretical effective drive. A difference value between the target effective drive and the theoretical effective drive being less than or equal to 5 may be understood as that values of the effective drive obtained by the fitting curve are the same as or similar to values of the actually applied target effective drive.

Optionally, the difference value between the target effective drive and the theoretical effective drive is less than or equal to 2.

Further, the difference value between the target effective drive and the theoretical effective drive is less than or equal to 1.

In some embodiments, referring to FIG. 4, the electrophoretic display panel is under the driving of 64 gray scales, when the target gray scale is the fixed value and the initial gray scale is 0 (y=0), the difference value between the target effective drive and the theoretical effective drive is less than or equal to 5; when the initial gray scale ranges from 5 to 8 (y=5, y=6, y=7 or y=8), the difference value between the target effective drive and the theoretical effective drive is less than or equal to 2; and when the initial gray scale takes other value, the difference value between the target effective drive and the theoretical effective drive is less than or equal to 1.

When the target gray scale is the fixed value, a value of a target effective drive corresponding to the initial gray scale is stored in the driving chip. In the electrophoretic display panel, a discrete value of the effective drive may be acquired by directly looking up the table in the driving chip, that is, a value of the target effective drive is obtained by directly looking up the table, further an accurate driving waveform is acquired, and then the gray scale is adjusted according to the driving waveform, whereby the speed and the accuracy of adjustment of the gray scale can be improved.

Specifically, FIG. 4 illustrates the acquisition of discrete points and the fitting of the equation of the electrophoretic display panel under the driving of the 64 gray scales. When the target gray scale is the fixed value, an equation obtained by fitting satisfies: an equation (1),

$${V}_{l} = \frac{64}{n} Ax + B ,$$

where x denotes the initial gray scale, y denotes the target gray scale, Vₗ denotes the theoretical effective drive, each of x and y is an integer, and n is the number of gray scales of the electrophoretic display panel in one driving mode, and where 0.23<A<0.29, and −20<B<10. In the current embodiment, n is the number of gray scales of the electrophoretic display panel in a 64 gray scale driving mode, and n is equal to 64. In other embodiments, n may take other positive integer values, values of n are not limited in the present disclosure, and n may be odd numbers or even numbers. For example, A may be 0.26. In some embodiments, a an equation obtained by fitting may be Vₗ=0.2688x+5.75 or Vₗ=0.2688x−15.375. Specific values of A and B may be adaptively adjusted according to the difference of the selected target gray scales, which is not specifically limited in the embodiments of the present disclosure.

Optionally, when n is 63,

$$\frac{64}{n}$$

in

$${V}_{l} = \frac{64}{n} Ax + B$$

is a non-integer, a correction may be performed on

$$\frac{64}{n}$$

in combination with A, that is, the coefficient before the initial grayscale in the equation (1) is used as the variable is determined by

$$\frac{64}{n}$$

### and A.

In some embodiments, 0.234<A<0.286, the significant digit of A may be determined according to the test and the fitting precision, and the numerical precision of A may be determined to 2 bits, 3 bits, or 4 bits significant digits as required. Other parameters are similar to A and may also be determined according to the test and the fitting precision.

In some embodiments, referring to FIG. 4, two types of discrete points are shown in FIG. 4. One type of discrete point is a discrete point of a target effective drive obtained under different initial gray scales when the target gray scale is zero (i.e., y=0). The other type of discrete point is a discrete point of a target effective drive obtained under different initial gray scales when the target gray scale is 63 (i.e., y=63). FIG. 4 further shows fitting relationships corresponding to different target gray scales, one fitting relationship is a fitting curve (referring to a fitting curve s1 in FIG. 4) corresponding to the initial gray scale and the theoretical effective drive when the target gray scale is zero (that is, y=0); and one fitting relationship is a fitting curve corresponding to the initial gray scale and the theoretical effective drive when the target gray scale is 63 (that is, y=63) (referring to the fitting curve s2 in FIG. 4). With reference to FIG. 4, when the target gray scale is zero, a difference value of effective drives between the target effective drive and the theoretical effective drive is relatively small, when the initial gray scale is 0, the difference value between the target effective drive and the theoretical effective drive is equal to 5, and when the initial gray scale ranges from 1 to 63, the difference value between the target effective drive and the theoretical effective drive is less than 5, preferably less than 2 or 1. Similarly, when the target gray scale is 63, a difference value of effective drives between the target effective drive and the theoretical effective drive is relatively small, when the initial gray scale is 0, the difference value between the target effective drive and the theoretical effective drive is equal to 5, and when the initial gray scale ranges from 1 to 63, the difference value between the target effective drive and the theoretical effective drive is less than 5, preferably less than 2 or 1.

As shown in FIG. 4, when the target gray scale is zero and the initial gray scale ranges from 1 to 63, the difference value between the target effective drive and the theoretical effective drive is less than or equal to 2. When the target gray scale is 63 and the initial gray scale ranges from 1 to 63, the difference value between the target effective drive and the theoretical effective drive is less than or equal to 2.

The fitting curve s1 represents a rule that values (i.e., discrete points near the fitting curve s1 in FIG. 4) of target effective drives are complied with when the target gray scale is zero. The fitting curve s2 represents a rule that values (i.e., discrete points near the fitting curve s2 in FIG. 4) of target effective drives are complied with when the target gray scale is 63. It is to be understood that, under the driving of the driving waveform, a gray scale test is performed on one electrophoretic display panel. According to the measured gray scale data of the electrophoretic display panel, the linear fitting is performed when the target gray scale is the fixed value, and a coefficient of a linear fitting line satisfies the range of the embodiments of the present disclosure, that is, the coefficient of the linear fitting line satisfies that a slope is greater than 0.234 or less than 0.286, an intercept is greater than −20 and less than 10, and a difference value between a value of a corresponding measured effective drive and a value on the linear fitting line does not exceed 5.

The fitting curve s1 and the fitting curve s2 are straight lines. A slope of the fitting curve s1 and a slope of the fitting curve s2 are almost unchanged, or a slope of the fitting curve s1 changes little compared to a slope of the fitting curve s2. Although a fitting result that the target gray scale of zero and the target gray scale of 63 in the 64 gray scale driving mode is exemplarily illustrated in FIG. 4, and a fitting result that the target gray scale ranges from 1 to 62 in the 64 gray scale driving mode is not illustrated in FIG. 4. It can be seen from FIG. 4 that fitting curves with the target gray scale ranging from 1 to 62 are sequentially distributed between the fitting curve s1 and the fitting curve s2 one by one. When the value of the target gray scale changes, for example, the target gray scale changes from 0 to 63, the slope of the fitting curve is almost unchanged, and the intercept of the fitting curve changes.

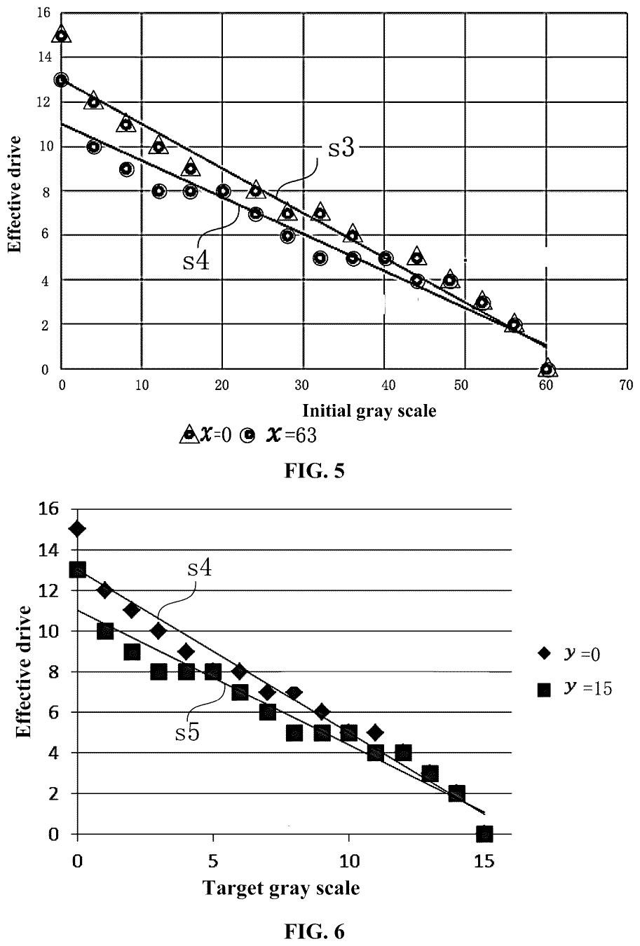

FIG. 5 is a schematic diagram of a relationship between an initial gray scale and an effective drive according to an embodiment of the present disclosure. Referring to FIG. 5, a value of an abscissa in FIG. 5 represents a value of the target gray scale, and a value of an ordinate in FIG. 5 represents a value of the effective drive. FIG. 5 shows multiple discrete points, an effective drive corresponding to the discrete point is the target effective drive. The discrete point may be understood as a point determined in the coordinate system by a value of a certain target gray scale and a value of a certain effective drive when the initial gray scale is a fixed value. Two fitting curves (s3 and s4 shown in FIG. 5) are shown in FIG. 5, where the fitting curve is an equation that the theoretical effective drive and the target gray scale are used as variables when the initial gray scale is the fixed value, and an effective drive that may be obtained by substituting the target gray scale into the equation is the theoretical effective drive. The difference value between the target effective drive and the theoretical effective drive being less than or equal to 5 may be understood as that values of the effective drive obtained by the fitting curve are the same as or similar to values of the actually applied target effective drive.

In some embodiments, referring to FIG. 5, the electrophoretic display panel is under the driving of the 64 gray scales, when the target gray scale is the fixed value and the target gray scale is 0 (x=0), the difference value between the target effective drive and the theoretical effective drive is less than or equal to 5; when the target gray scale is 5 (x=5), the difference value between the target effective drive and the theoretical effective drive is less than or equal to 2; and when the target gray scale takes other value, the difference value between the target effective drive and the theoretical effective drive is less than or equal to 1.

When the initial gray scale is the fixed value, a value of a target effective drive corresponding to the target gray scale is stored in the driving chip. In the electrophoretic display panel, a discrete value of the effective drive may be acquired by directly looking up the table in the driving chip, that is, a value of the target effective drive is obtained by directly looking up the table, further an accurate driving waveform is acquired, and then the gray scale is adjusted according to the driving waveform, whereby the speed and the accuracy of adjustment of the gray scale can be improved.

Specifically, FIG. 5 illustrates the acquisition of discrete points and the fitting of the equation of the electrophoretic display panel under the driving of the 64 gray scales. When the target gray scale is the fixed value, an equation obtained by fitting satisfies: an equation (2),

$${V}_{l} = \frac{64}{n} Cy + D ,$$

where x is the initial gray scale, y denotes the target gray scale, Vₗ denotes the theoretical effective drive, each of x and y is an integer, and n is the number of gray scales of the electrophoretic display panel in one driving mode, and where −0.22<C<−0.10 and 0<D<25. For example, C may be −0.18, in some embodiments, an equation obtained by fitting may be Vₗ=−0.2007x+13.022 or Vₗ=−0.1658x+11.037. The specific value of C and D may be adaptively adjusted according to the difference of the selected initial gray scales, which is not specifically limited in the embodiments of the present disclosure.

Optionally, when n is 63,

$$\frac{64}{n}$$

in

$${V}_{l} = \frac{64}{n} Cy + D$$

is a non-integer, a correction may be performed on

$$\frac{64}{n}$$

in combination with C, that is, the coefficient before the initial grayscale in the equation (2) is used as the variable is determined by

$$\frac{64}{n}$$

### and A.

In some embodiments, −0.216<C<−0.144, the significant digit of C may be determined according to the test and the fitting precision, and the numerical precision of C may be determined to 2 bits, 3 bits, or 4 bits significant digits as required.

In some embodiments, referring to FIG. 5, two types of coordinate points are shown in FIG. 5. One type of coordinate point is a discrete point of a target effective drive obtained under different target gray scales when the initial gray scale is zero (i.e., x=0). The other type of coordinate point is a discrete point of a target effective drive obtained under different target gray scales when the initial gray scale is 63 (i.e., x=63). FIG. 5 further shows fitting relationships corresponding to different target gray scales, one fitting relationship is a fitting curve (referring to a fitting curve s3 in FIG. 5) corresponding to the target gray scale and the theoretical effective drive when the initial gray scale is zero (i.e., x=0); and one fitting relationship is a fitting curve (referring to the fitting curve s4 in FIG. 5) corresponding to the target gray scale and the theoretical effective drive when the initial gray scale is 63 (that is, x=63). With reference to FIG. 5, when the initial gray scale is zero, a different value of effective drives between the target effective drive and the theoretical effective drive is relatively mall, when the target gray scale is 0, the difference value between the target effective drive and the theoretical effective drive is equal to 5, and when the target gray scale ranges from 1 to 63, the difference value between the target effective drive and the theoretical effective drive is less than 5, preferably less than 2 or 1. Similarly, when the initial gray scale is 63, a difference value of effective drives between the target effective drive and the theoretical effective drive is relatively small, when the target gray scale is 0, the difference value between the target effective drive and the theoretical effective drive is equal to 5, and when the target gray scale ranges from 1 to 63, the difference value between the target effective drive and the theoretical effective drive is less than 5, preferably less than 2 or 1.

As shown in FIG. 5, when the initial gray scale is zero and the target gray scale ranges from 1 to 63, the difference value between the target effective drive and the theoretical effective drive is less than or equal to 2. When the initial gray scale is 63 and the target gray scale ranges from 1 to 63, the difference value between the target effective drive and the theoretical effective drive is less than or equal to 2.

The fitting curve s3 represents a rule that values (i.e., discrete points near the fitting curve s3 in FIG. 5) of target effective drives are complied with when the initial gray scale is zero. The fitting curve s4 represents a rule that values (i.e., discrete points near the fitting curve s4 in FIG. 5) of the target effective drives are complied with when the initial gray scale is 63. It is to be understood that, under the driving of the driving waveform, a gray scale test is performed on one electrophoretic display panel. According to the measured gray scale data of the electrophoretic display panel, the linear fitting is performed when the initial gray scale is the fixed value, and a coefficient of a linear fitting line satisfies the range of the embodiments of the present disclosure, that is, the coefficient of the linear fitting line satisfies that a slope is greater than −0.216 or less than −0.144, an intercept is greater than 0 and less than 25, and a difference value between a value of a corresponding measured effective drive and a value on the linear fitting line does not exceed 5.

The fitting curve s3 and the fitting curve s4 are straight lines. A slope of the fitting curve s3 and a slope of the fitting curve s4 are almost unchanged, or a slope of the fitting curve s3 changes little compared to a slope of the fitting curve s4. Although a fitting result that the initial gray scale of zero and the initial gray scale of 63 in the 64 gray scale driving mode is exemplarily illustrated in FIG. 5, and a fitting result that the initial gray scale ranges from 1 to 62 in the 64 gray scale driving mode is not illustrated in FIG. 5. It can be seen from FIG. 5 that fitting curves with the initial gray scale ranging from 1 to 62 are sequentially distributed between the fitting curve s3 and the fitting curve s4 one by one. When the value of the initial gray scale changes, for example, the initial gray scale changes from 0 to 63, the slope of the fitting curve is almost unchanged, and the intercept of the fitting curve changes.

In the electrophoretic display panel provided in the embodiments of the present disclosure, the theoretical effective drive satisfies the equation (1) and/or the equation (2), the difference value between the target effective drive and the theoretical effective drive is relatively small, and the rule satisfied by each numerical point of the target effective drive may be described by using the equation satisfied by the theoretical effective drive. The driving waveform determined according to the target effective drive is relatively accurate. Moreover, during debugging, a value of the theoretical effective drive is obtained according to the equation (1) and/or the equation (2), a test is performed near the value of the theoretical effective drive based on the value of the theoretical effective drive, and a suitable value of the effective drive is found as the target effective drive. Compared with blind debugging without any basis, the speed and accuracy of adjustment of the gray scale are improved, and thus the calibration difficulty of the gray scale in the process of testing the electrophoretic display panel can be reduced.

It is to be noted that the initial gray scale x, the target gray scale y, and the theoretical effective drive Vₗ may constitute a ternary equation, the initial gray scale x and the target gray scale y are variables, and the value obtained by the theoretical effective drive Vₗ according to the two variables has a larger error than a value obtained by the theoretical effective drive Vₗ according to one variable by fixing one of the initial gray level x and the target gray level y. Therefore, in the embodiments of the present invention, the target gray scale y is fixed, so that the theoretical effective drive Vₗ satisfies the equation (1); and/or the initial gray scale x is fixed, so that the theoretical effective drive Vₗ satisfies the equation (2).

Optionally, referring to FIG. 4, 0.24<A<0.28.

In the equation (1), when the target gray scale is the fixed value, the theoretical effective drive satisfies: Vₗ=Ax+B, and 0.23<A<0.29. Further, referring to FIG. 4, the slopes of the fitting curves corresponding to both the equation (1) (referring to the fitting curve s1 in FIG. 4) corresponding to when the target gray scale is 0 (i.e., y=0) and the equation (1) (referring to the fitting curve s2 in FIG. 4) corresponding to when the target gray scale is 63 (i.e., y=63) are the same or similar. The equation (1) corresponding to when the target gray scale is 0 and the equation (1) corresponding to when the target gray scale is 63 may be understood as an upper limit and a lower limit of the slope change of the equation (1) when the electrophoretic display panel is driven by the 64 gray scales, in this way, when the target gray scale takes other values, the change degree of the slope is smaller. Therefore, values of the slope in the equation (1) are similar to each other at different target gray levels.

Further, 0.247<A<0.273 may be selected.

Specifically, the slope satisfies 0.247<A<0.273. Therefore, it is to be understood that when the target gray scale is at different values, the slope of the equation (1) is almost constant, and the variation thereof is not more than 5%. In this way, it is ensured that the difference value between the theoretical effective drive and the target effective drive is relatively small, so that the theoretical effective drive for determining the driving waveform is relatively accurate, and the driving waveform is accurate and reliable. In the electrophoretic display panel, the gray scale is adjusted according to the driving waveform, so that the speed and the accuracy of adjustment of the gray scale are improved, and further the calibration difficulty of the gray scale in the test process of the electrophoretic display panel may be reduced.

Optionally, referring to FIG. 4, under the driving of the 64 gray scales, when y=0, Vₗ=0.2688x+B, where 0.75≤B<10; and/or under the driving of the 64 gray scales, when y=63, Vₗ=0.2798x+B, where −20<B≤−10.581.

In the equation (1), when the target gray scale is the fixed value, the theoretical effective drive satisfies Vₗ=Ax+B, and −20<B≤10. The target gray scale being zero and the target gray scale being 63 under the driving of the 64 gray scales may be understood as two upper and lower limits of the equation (1) under the driving of 64 gray scales of the electrophoretic display panel. An intercept of the upper limit and an intercept of the lower limit of the fitting curve are acquired, the numerical range of B in the equation (1) may be determined more accurately, thereby ensuring that the difference value between the theoretical effective drive and the target effective drive is relatively small.

Further, referring to FIG. 4, for the equation (1), when the target gray scale is 0, that is, y=0 (referring to the fitting curve s1 in FIG. 5), the equation (1) satisfies: Vₗ=0.2688x+B, and the slope is selected to be 0.2688. A corresponding intercept B satisfies 0.75≤B<10, in some embodiments, B may be 5.75. When the target gray scale is 0, a range of the intercept of the equation (1) is determined.

Further, referring to FIG. 4, for the equation (1), when the target gray scale is 63, that is, y=63 (referring to the fitting curve s2 in FIG. 5), and the equation (1) satisfies Vₗ=0.2798x+B, that is, the slope A is selected to be 0.2798. The corresponding intercept B satisfies −20<B≤−10.581, in some embodiments, B may be −15.375. When the target gray scale is 63, a range of the intercept of the equation (1) is determined.

Further, as shown in FIG. 4, the intercept of the equation (1) may be determined according to the target gray scale being 0 and the target gray scale being 63, and B satisfies −20<B≤10.

Specifically, after the value of the target gray scale in the equation (1) is determined, a corresponding slope may be determined, and further, in order to ensure that a difference between the equation (1) and values of multiple discrete points is relatively small, that is, the difference value between the target effective drive and the theoretical effective drive is relatively small, the intercept may be limited in a range, so that the fitting equation (1) is more accurate and reliable, the theoretical effective drive for determining the driving waveform is relatively accurate, and the driving waveform is accurate and reliable. In the electrophoretic display panel, the gray scale is adjusted according to the driving waveform, so that the speed and the accuracy of adjustment of the gray scale are improved, and further the calibration difficulty of the gray scale in the test process of the electrophoretic display panel may be reduced.

Optionally, referring to FIG. 5, under the driving of the 64 gray scales, when x=0, Vₗ=−0.2007y+13.022; and/or, under the driving of the 64 gray scales, when x=63, Vₗ=−0.1658y+11.037.

In the equation (2), when the initial gray scale is the fixed value, the theoretical effective drive satisfies Vₗ=Cx+D. Under the driving of the 64 gray scales, the initial gray scale being zero and the initial gray scale being 63 may be understood as two upper and lower limits of the equation (2) under the driving of the 64 gray scales of the electrophoretic display panel. A slope and an intercept of the upper limit of the fitting curve and a slope and an intercept of the lower limit of the fitting curve are acquired, the equation (2) may be determined more accurately, thereby ensuring that the difference value between the theoretical effective drive and the target effective drive is relatively small.

Further, referring to FIG. 5, for the equation (2), when the initial gray scale is 0, that is, x=0, the equation (2) satisfies Vₗ=−0.2007y+13.022 (referring to the fitting curve s3 in FIG. 5), that is, the slope is selected to be −0.2007. A corresponding intercept D is selected to be 13.022. When the initial gray scale is 0, the equation (2) is determined.

Further, referring to FIG. 5, for the equation (2), when the initial gray scale is 63, that is, x=63, the equation (2) satisfies Vₗ=−0.1658y+11.037 (referring to the fitting curve s4 in FIG. 5), that is, the slope D is selected to be −0.1658. A corresponding intercept D is selected to be 11.037. When the initial gray scale is 63, the upper limit of the equation (2) is determined.

Further, referring to FIG. 5, for the equation (2), the slope and the intercept may be determined in combination with the initial gray scale being 0 and the initial gray scale being 63, whereby the equation (2) is ensured to be more accurate and reliable, thereby ensuring that the calculated theoretical effective drive is more accurate and reliable, and reducing the calibration difficulty of the gray scale in the test process of the electrophoretic display panel.

Optionally, under the driving of 16 gray scales, when the target gray scale is fixed, Vₗ=Ex+F, where 0.99<E<1.21 and −20<F<10.

Further, the acquisition of discrete points and the fitting of the equation of the electrophoretic display panel under the driving of 16 gray levels are described. When the target gray scale is the fixed value, a relationship obtained by the fitting satisfies Vₗ=Ex+F, where x is the initial gray scale, y denotes the target gray scale, Vₗ denotes the theoretical effective drive, and each of x and y is an integer, where 0.99<E<1.21 and −20<F<10. In some embodiments, E may be 1.1. The specific values of E and F may be adaptively adjusted according to the difference of the selected gray scales. Further, when the target gray scale is the fixed value, the theoretical effective drive satisfies

$${V}_{l} = \frac{64}{n} Ax + B .$$

On the basis of the above, Vₗ=Ex+F is satisfied, where 0.99<E<1.21 and −20<F<10.

1.0<E<1.2. Further, 1.045<E<1.155.

Optionally, under the driving of the 16 gray scales, the initial gray scale is fixed, Vₗ=Gy+H, where −0.9<G<−0.6 and 0<H<25.

Further, the acquisition of discrete points and the fitting of the equation of the electrophoretic display panel under the driving of the 16 gray levels are described. When the initial gray scale is the fixed value, a relationship obtained by the fitting satisfies Vₗ=Gy+H, where x is the initial gray scale, y denotes the target gray scale, Vₗ denotes the theoretical effective drive, and each of x and y is an integer, where −0.9<G<−0.6 and 0<H<25. In some embodiments, G may be −0.75. The specific values of G and H may be adaptively adjusted according to requirements.

Optionally, FIG. 6 is another schematic diagram of a relationship between a target gray scale and an effective drive according to an embodiment of the present disclosure. Referring to FIG. 6, under the driving of the 16 gray scales, when x=0, Vₗ=−0.6632y+11.037; and/or, under the driving of the 16 gray scales, when x=15, Vₗ=−0.8029y+13.022.

FIG. 6 is a schematic diagram of a relationship between a target gray scale and an effective drive according to an embodiment of the present disclosure. Referring to FIG. 6, a value of an abscissa in FIG. 6 represents a value of the target gray scale, a value of an ordinate in FIG. 6 represents a value of the effective drive. FIG. 6 shows multiple discrete points, an effective drive corresponding to the discrete point is the target effective drives. The discrete point may be understood as a point determined in the coordinate system by a value of a certain target gray scale and a value of a certain effective drive when the initial gray scale is a fixed value. Two fitting curves (s4 and s5 shown in FIG. 6) are shown in FIG. 6, where the fitting curve is an equation that the theoretical effective drive and the target gray scale are used as variables when the initial gray scale is the fixed value, and an effective drive that may be obtained by substituting the target gray scale into the equation is the theoretical effective drive. The difference value between the target effective drive and the theoretical effective drive being less than or equal to 5 may be understood as that values of the effective drive obtained by the fitting curve are the same as or similar to values of the actually applied target effective drive.

Specifically, FIG. 6 illustrates the acquisition of discrete points and the fitting of the equation of the electrophoretic display panel under the driving of the 16 gray scales. It is to be noted that the discrete points under the driving of the 16 gray scales may be understood as part of the discrete points selected under the driving of the 64 gray scales. The theoretically effective drive satisfies the following equation: when the initial gray scale is fixed,

$${V}_{l} = \frac{64}{n} Cy + D ,$$

n is the number of gray scales of the electrophoretic display panel in one driving mode; therefore, under the driving of the 64 gray scales, n is selected to be 16; and under the driving of the 16 gray scales, n is selected to be 16. For the same electrophoretic display panel, it may be adjusted to the 64 gray scale driving or the 16 gray scale driving, and the specific value of n is adaptively adjusted according to actual requirements. In some embodiments, when the electrophoretic display panel is under the driving of 16 gray scales, an equation obtained by the fitting may be Vₗ=−0.6632x+11.037 or Vₗ=−0.8029+13.022. The specific values of C and D may be adaptively adjusted according to the difference value of the selected initial gray scales, which are not specifically limited in the embodiments of the present disclosure, for example, a slope under the driving of the 64 gray scales is four times a slope under the driving of the 16 gray scales, and an intercept under the driving of 64 gray scales is four times an intercept under the driving of 16 gray scales.

In some embodiments, referring to FIG. 6, two types of coordinate points are shown in FIG. 6. One type of coordinate point is a discrete point of a target effective drive obtained under different target gray scales when the initial gray scale is zero (i.e., =0). The other type of coordinate point is a discrete point of a target effective drive obtained under different target gray scales when the initial gray scale is 15 (i.e., x=15). FIG. 6 further shows a fitting relationship corresponding to different target gray scales, one fitting relationship is a fitting curve (referring to the fitting curve s5 in FIG. 6) corresponding to the target gray scale and the theoretical effective drive when the initial gray scale is zero (i.e., x=0); and one fitting relationship is a fitting curve (referring to the fitting curve s6 in FIG. 6) corresponding to the target gray scale and the theoretical effective drive when the initial gray scale is 15 (that is, x=15). With reference to FIG. 6, when the initial gray scale is zero, a difference value of effective drives between the target effective drive and the theoretical effective drive is relatively small, when the target gray scale is 0, the difference value between the target effective drive and the theoretical effective drive is equal to 5, and when the target gray scale is 1 to 15, the difference value between the target effective drive and the theoretical effective drive is less than 5. Similarly, when the initial gray scale is 15, a difference value of effective drives between the target effective drive and the theoretical effective drive is relatively small, when the target gray scale is 0, the difference value between the target effective drive and the theoretical effective drive is equal to 5, and when the target gray scale ranges from 1 to 15, the difference value between the target effective drive and the theoretical effective drive is less than 5.

As shown in FIG. 6, when the initial gray scale is zero and the target gray scale ranges from 1 to 15, the difference value between the target effective drive and the theoretical effective drive is less than or equal to 2. When the initial gray scale is 15 and the target gray scale ranges from 1 to 15, the difference value between the target effective drive and the theoretical effective drive is less than or equal to 2.

The fitting curve s5 represents a rule that the values (i.e., discrete points near the fitting curve s5 in FIG. 6) of the target effective drives are complied with when the initial gray scale is zero. The fitting curve s6 represents a rule that values (i.e., discrete points near the fitting curve s6 in FIG. 6) of the target effective drives are complied with when the initial gray scale is 15.

The fitting curve s5 and the fitting curve s6 are straight lines. A slope of the fitting curve s5 and a slope of the fitting curve s6 are almost unchanged, or a slope of the fitting curve s5 changes little compared to a slope of the fitting curve s6. Although a fitting result that the initial gray scale of zero and the initial gray scale of 15 in the 16 gray scale driving mode is exemplarily illustrated in FIG. 6, and a fitting result that the initial gray scale ranges from 1 to 14 in the 16 gray scale driving mode is not illustrated in FIG. 6. It can be seen from FIG. 6 that fitting curves with the initial gray scale ranging from 1 to 14 are sequentially distributed between the fitting curve s5 and the fitting curve s6 one by one. When the value of the initial gray scale changes, for example, the initial gray scale changes from 0 to 15, the slope of the fitting curve is almost unchanged, and the intercept of the fitting curve changes.

Further, in the equation (2), when the initial gray scale is the fixed value, the theoretical effective drive satisfies Vₗ=Cx+D. Under the driving of the 16 gray scales, the initial gray scale being zero and the initial gray scale being 15 may be understood as two upper and lower limits of the equation (2) under the driving of the 16 gray scales of the electrophoretic display panel. A slope and an intercept of the upper limit of the fitting curve and a slope and an intercept of the lower limit of the fitting curve are acquire, the equation (2) may be determined more accurately, thereby ensuring that the difference value between the theoretical effective drive and the target effective drive is relatively small.

Further, referring to FIG. 6, for the equation (2), when the initial gray scale is 0, that is, x=0, the equation (2) satisfies: Vₗ=−0.6632y+11.037 (referring to the fitting curve s5 in FIG. 6), that is, the slope is selected to be −0.6632. A corresponding intercept is selected to be 11.037. When the initial gray scale is 0, the equation (2) is determined.

Further, referring to FIG. 6, for the equation (2), when the initial gray scale is 15, that is, x=15, the equation (2) satisfies Vₗ=−0.8029y+13.022 (referring to the fitting curve s6 in FIG. 6), that is, the slope D is selected to be −0.8029. A corresponding intercept D is selected to be 13.022. When the initial gray scale is 150, the upper limit of the equation (2) is determined.

Further, referring to FIG. 6, for the equation (2), the slope and the intercept may be determined in combination with the initial gray scale being 0 and the initial gray scale being 15, whereby the equation (2) is ensured to be more accurate and reliable, thereby ensuring that the calculated theoretical effective drive is more accurate, and reducing the calibration difficulty of the gray scale in the test process of the electrophoretic display panel.

Optionally, referring to FIG. 3, a value of Vᵢ in the i-th unit period tᵢ includes 0, 1 or −1, the unit of Vᵢ is V0, V0 is a constant voltage, and a value of V0 is determined by the maximum driving voltage in the electrophoretic display panel.

The driving voltage of the data signal may be understood as the driving voltage in the driving waveform, for example, the driving voltage in the drive waveform may be 15V, 0, or −15V, that is, V0=15V In the i-th unit period tᵢ, the unit driving voltage of the data signal is Vᵢ, the unit driving voltage Vᵢ is a driving voltage after a normalization processing is performed, and Vᵢ includes any one value of 0, 1 or −1. That is, in a certain unit period tᵢ, Vᵢ may be any value of 0, 1, or −1. A duration of the unit period P0 is a duration of the scanning frame. Referring to FIG. 1, in one scanning frame, the scanning is performed row by row from a first scanning line 23 to a last scanning line 23. That is, one unit period P0 is a repeating period of the row signal. The effective drive represents an accumulated value of a product of voltage and time.

Further, referring to FIG. 4 to FIG. 6, the unit of the effective drive is (V (voltage)×S (second))/Vᵢ₀, for example, when the driving voltage of the data signal is 15V, the unit of the effective drive is (V(voltage)×S(second))/15.

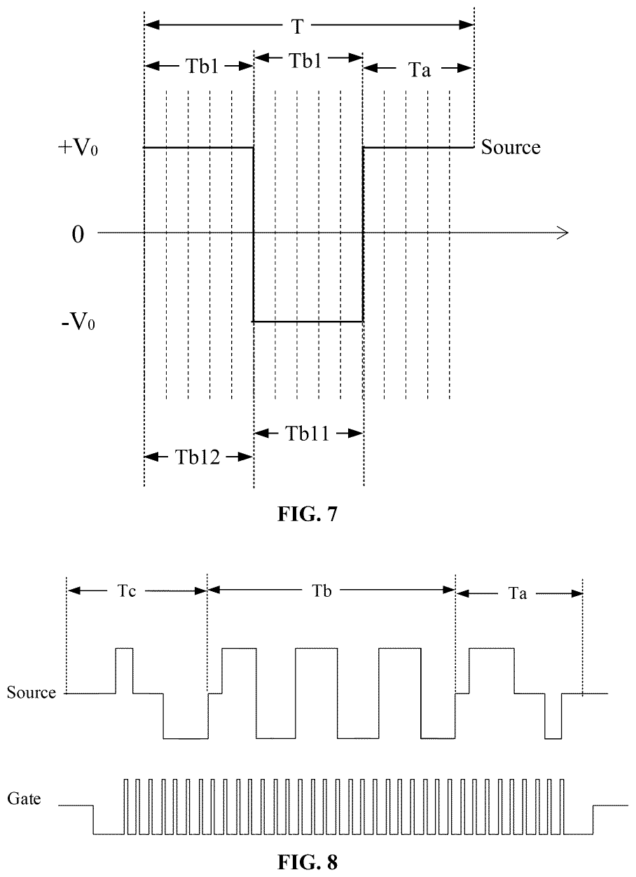

FIG. 7 is a drive timing graph of another electrophoretic display panel according to an embodiment of the present disclosure, and FIG. 8 is a drive timing graph of another electrophoretic display panel according to an embodiment of the present disclosure. Referring to FIG. 7 and FIG. 8, a driving stage T of the electrophoretic display panel 10 includes a writing stage Ta and an activation stage Tb, and the activation stage Tb is before the writing stage Ta. The activation stage Tb includes at least two sub-activation stages Tb1, and polarities of a driving voltage of the data signal in the at least two sub-activation stages are opposite.

Referring to FIG. 7 and FIG. 8, the driving stage T of the electrophoretic display panel 10 includes a writing stage Ta and an activation stage Tb, and the writing stage Ta writes different data signals Source into the at least two pixels 22. It is to be understood that the writing stage Ta is a stage for performing a differential operation, and different data signals Source are written into the at least two pixels 22 through the writing stage Ta, to achieve the image display of the electrophoretic display panel 10. The activation stage Tb provides the same data signal Source for different pixels 22, and the activation stage Tb is configured to activate electrophoretic particles to prevent the electrophoretic particles with different charges from being agglomerated.

Optionally, referring to FIG. 8, the driving stage T of the electrophoretic display panel 10 may further include an erase stage Tc, in the erase stage Tc, the same data signal Source is provided for different pixels 22, the different pixels 22 may have the same display brightness, the different pixels 22 may have the same gray scale, and the electrophoretic display panel 10 is driven to a uniform optical limit (a black gray scale or a white gray scale), which is conducive to eliminating the residual image of the previous frame, and before the drive signal of the writing stage Ta comes, the electrophoretic particles of each pixel 22 are at the same spatial position. Referring to FIG. 8, FIG. 8 shows a scanning signal Gate in which an interval between two pulses includes one unit period P0. In one unit period P0, the first scanning line is scanned to the last scanning line row by row. It is to be noted that if the pixel 22 remain in the same state for a long time, the mobility of the charged electrophoretic particles will increase, which is not conducive to displaying in the next stage. The optical limit can be reached by driving the electrophoretic display panel multiple times, thereby improving the activity of the electrophoretic particles.

Specifically, referring to FIG. 7, the activation stage Tb includes the at least two sub-activation stages Tb1, and polarities of a driving voltage of the data signal in the at least two sub-activation stages are opposite to each other. In FIG. 7, a driving voltage polarity of a data signal in a sub-activation stage Tb1 relatively close to the writing stage Ta in the timing sequence is negative, and in FIG. 7, a driving voltage polarity of a data signal in a sub-activation stage Tb1 relatively away from the writing stage Ta in the timing sequence is positive.

The above-described equations (1) and (2) are the accumulated values of the voltage multiplied by the unit time in the writing stage Ta and the activation stage Tb. If only one sub-activation stage Tb1 is set, an effective drive caused by the single sub-activation stage Tb1 is in a single direction, and numerical points of the effective drive are no longer applicable to the equation (1) and the equation (2). In this way, the setting number of the sub-activation stage Tb1 is adjusted to be at least two, it is ensured that the value of the effective drive satisfies the equation (1) and the equation (2), and then it can be ensured that the difference value between the theoretical effective drive and the target effective drive is relatively small, so that the theoretical effective drive for determining the driving waveform is relatively accurate, thereby improving the speed and the accuracy of adjustment of the gray scale, and reducing the calibration difficulty of the gray scale in the test process of the electrophoretic display panel.

With continued reference to FIG. 7, the at least two sub-activation stages Tb1 include a first sub-activation stage Tb11 and a second sub-activation stage Tb12, a driving voltage of the data signal in the first sub-activation stage Tb11 is equal in value but opposite in direction to a driving voltage of the data signal in the second sub-activation stage Tb12, and a duration of the first sub-activation stage Tb11 is equal to a duration of the second sub-activation stage Tb12.

Specifically, referring to FIG. 7, the activation stage Tb includes at least two sub-activation stages Tb1, the two sub-activation stages Tb1 are a first sub-activation stage Tb11 and a second sub-activation stage Tb12, and a polarity of the driving voltage of the data signal in the first sub-activation stage Tb11 is opposite to a polarity of the driving voltage of the data signal in the second sub-activation stage Tb12. Moreover, an absolute value of the driving voltage of the data signal in the first sub-activation stage Tb11 is the same as an absolute value of the driving voltage of the data signal in the second sub-activation stage Tb12, which may be understood as that the driving voltage of the data signal in the first sub-activation stage Tb11 is V₀, and the driving voltage of the data signal in the second sub-activation stage Tb12 is −V₀. Further, a duration of the first sub-activation stage Tb11 is equal to a duration of the second sub-activation stage Tb12. Referring to FIG. 3 and FIG. 7, the first sub-activation stage Tb11 includes 5 unit periods P0, and the second sub-activation stage Tb12 also includes 5 unit periods P0, to ensure that a duration of the first sub-activation stage Tb11 is equal to the duration of the second sub-activation stage Tb12. The number of unit periods P0 included in both the first sub-activation stage Tb11 and the second sub-activation stage Tb12 may be adaptively adjusted according to different conditions.

As described above, in the i-th unit period tᵢ, the driving voltage of the data signal is Vᵢ₀, and it satisfies Vᵢ₀=Vᵢ×V₀. The driving voltage of the data signal during the total period of the first sub-activation stage Tb11 plus the second sub-activation stage Tb12 is zero. The voltage in the writing stage Ta multiplied by the accumulated value per unit time satisfies the above-described equation (1) and equation (2), so that the theoretical effective drive of the driving waveform is relatively accurate, and thus the speed and the accuracy of adjustment of the gray scale are improved.

FIG. 9 is a drive timing graph of another electrophoretic display panel according to an embodiment of the present disclosure, referring to FIG. 9, the at least two sub-activation stages Tb1 include a first sub-activation stage Tb11 and a second sub-activation stage Tb12, the driving voltage of the data signal in the first sub-activation stage Tb11 is equal in value but opposite in direction to a driving voltage of the data signal in the second sub-activation stage Tb12, the second sub-activation stage Tb12 is located between the first sub-activation stage Tb1 and the writing stage Ta, and a polarity of a voltage in the second sub-activation stage Tb12 is the same as a polarity of a voltage in the writing stage Ta. In the writing stage Ta, the data signal includes a write driving signal and a DC balance signal, a duration difference Td is obtained by subtracting a duration of the second sub-activation stage Tb12 from a duration of the first sub-activation stage Tb11, and a duration of the DC balance signal is equal to the duration difference.

Specifically, referring to FIG. 9, the activation stage Tb includes at least two sub-activation stages Tb1, the two sub-activation stages Tb1 are a first sub-activation stage Tb11 and a second sub-activation stage Tb12, and a polarity of the driving voltage of the data signal in the first sub-activation stage Tb11 is opposite to a polarity of the driving voltage of the data signal in the second sub-activation stage Tb12. Moreover, an absolute value of the driving voltage of the data signal in the first sub-activation stage Tb11 is the same as an absolute value of the driving voltage of the data signal in the second sub-activation stage Tb12, which may be understood as that the driving voltage of the data signal in the first sub-activation stage Tb11 is V₀, and the driving voltage of the data signal in the second sub-activation stage Tb12 is −V₀. Further, a duration of the first sub-activation stage Tb11 is not equal to a duration of the second sub-activation stage Tb12. Referring to FIG. 3 and FIG. 9, the first sub-activation stage Tb11 includes 5 unit periods P0, and the second sub-activation stage Tb12 also includes 6 unit periods P0. The number of unit periods P0 included in both the first sub-activation stage Tb11 and the second sub-activation stage Tb12 may be adaptively adjusted according to different conditions. The duration of the second sub-activation stage Tb12 minus the duration of the first sub-activation stage Tb11 is a duration difference Td, and the duration of the second sub-activation stage Tb12 minus the duration of the first sub-activation stage Tb11 in FIG. 9 is one unit period P0.

Further, in the writing stage Ta, the data signal includes a write driving signal and a DC balance signal, where an input of the DC balance signal is to ensure the DC balance, and the DC balance may be understood to be the balance of the direct current signal, that is, an integral of an applied voltage with respect to time is zero. A duration difference Td is obtained by subtracting a duration of the second sub-activation period Tb12 from a duration of the first sub-activation period Tb11, as shown in FIG. 9, the duration of the DC balance signal is equal to the duration difference Td. It may be understood as that since the duration of the first sub-activation stage Tb11 is not equal to the duration of the second sub-activation stage Tb12, the common effective drive of the activation waveform in the first sub-activation stage Tb11 and the activation waveform in the second sub-activation stage Tb12 is not 0. This difference is compensated in the driving waveform of the writing stage Ta.

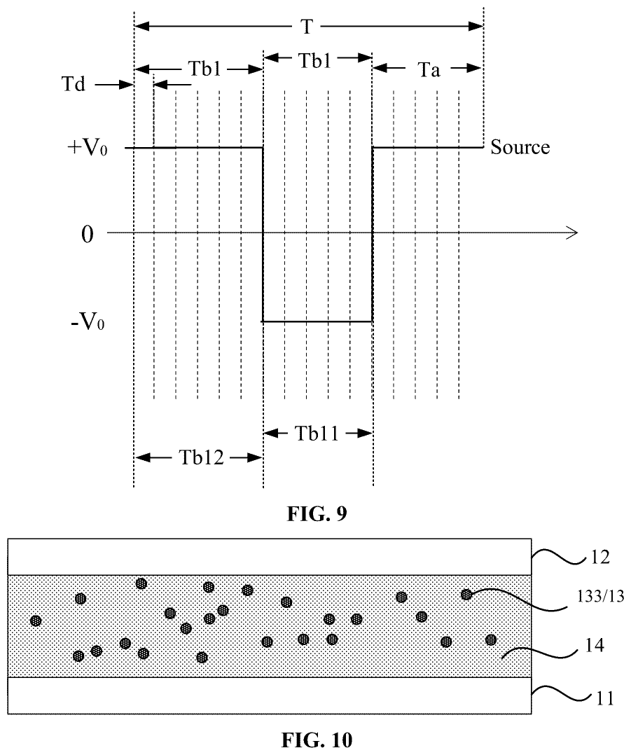

FIG. 10 is a sectional view of another electrophoretic display panel according to an embodiment of the present disclosure. FIG. 11 is a sectional view of another electrophoretic display panel according to an embodiment of the present disclosure. Referring to FIG. 1, FIG. 2, FIG. 10 and FIG. 11, the electrophoretic display panel 10 further includes a first substrate 11, an electrophoretic fluid 14 and multiple electrophoretic particles 13. The data line 21 and the pixel 22 are located on the same side of the first substrate 11 facing the electrophoretic particles 13, and the electrophoretic particles 13 are charged particles doped in the electrophoretic fluid 14.

Specifically, referring to FIG. 2, FIG. 10 and FIG. 11, the electrophoretic display panel 10 includes a first substrate 11, an electrophoretic fluid 14 and multiple electrophoretic particles 13. The electrophoretic display panel 10 further includes a second substrate 12, the electrophoretic fluid 14 is located in a space formed by the first substrate 11 and the second substrate 12, and the electrophoretic particles 13 are doped in the electrophoretic fluid 14. The electrophoretic display panel 10 further includes a first electrode (not shown in the drawings) located on a side of the first substrate 11 facing the second substrate 12, and a second electrode (not shown in the drawings) located on a side of the second substrate 12 facing the first substrate 11. A voltage is applied between the first electrode and the second electrode, the electrophoretic particles 14 are driven to move in position, so that the pixels 22 can present different display images, and further, the color display effect of the pixels 22 can be achieved according to the color diversity setting of the electrophoretic fluid 14 and the electrophoretic particles 13.

Specifically, the setting manners for the electrophoretic particles are diverse, as described below.

Referring to FIG. 2, the multiple electrophoretic particles 13 includes a first electrophoretic particle 131 and a second electrophoretic particle 132, and the first electrophoretic particle 131 and the second electrophoretic particle 132 have different colors.

The electrophoretic particles 13 include a first electrophoretic particle 131 and a second electrophoretic particle 132, and the first electrophoretic particle 131 and the second electrophoretic particle 132 have different extensions, so that the electrophoretic display panel 10 is a dual-particle system. In some embodiments, the electrophoretic particle 13 may include a black electrophoretic particle and a white electrophoretic particle, and the electrophoretic fluid 14 may be a colorless and transparent liquid. Under the action of the electric field provided by the first electrode and the second electrode, when the black electrophoretic particle is located on the display side of the electrophoretic display panel (for example, the side of the second substrate 12 facing away from the first substrate 11), the light is absorbed by the black electrophoretic particle, so that the light reflected to the human eyes is less, and the dark region is viewed by the human eyes, for example, the gray scale value is recorded as 0. When the white electrophoretic particle is located on the display side of the electrophoretic display panel, the light is reflected by the white electrophoretic particle, so that more light is reflected to the human eyes, it appears to the human eyes as the bright region, such as, with the gray scale value of 63 or 15. When the black electrophoretic particle and the white electrophoretic particle are located between the second substrate 12 and the first substrate 11, part of the light is reflected and part of the light is absorbed, the gray region is viewed by the human eyes, and the gray level value is between 0 and 64 or between 0 to 15.

Referring to FIG. 10, the electrophoretic fluid 14 and the electrophoretic particle 13 have different colors.

The electrophoretic fluid 14 and the electrophoretic particle 13 may both be in a colored state, and the electrophoretic fluid 14 and the electrophoretic particle 13 have different colors. In some embodiments, referring to FIG. 10, the electrophoretic fluid 14 is a black liquid, the electrophoretic particle 133 is the white electrophoretic particle, and the white charged particles doped in the black electrophoretic fluid are driven by the voltage between the first electrode and the second electrode, so that each pixel may display the required gray scale. Specifically, when the white electrophoretic particle is located on the non-display side of the electrophoretic display panel (for example, the side of the second substrate 12 close to the first substrate 11), the light is absorbed by the black electrophoretic fluid, so that the light reflected to the human eyes is less, and the dark region is seen by the human eyes. When the white electrophoretic particle is located on the display side of the electrophoretic display panel, the light is reflected by the white electrophoretic particle, so that more light is reflected to the human eyes, and the light is viewed as a bright region in the human eyes.

Optionally, the electrophoretic particle 13 included in the electrophoretic display panel 10 shown in FIG. 11 is the white particle, the electrophoretic display panel 10 further includes a black substrate 15 on a side of close to the first substrate 11, and the electrophoretic particles 13 may be doped in the colorless transparent electrophoretic fluid 14. When the white particles are converged together under the action of the electric field, the liquid is transparent, and the black substrate may be seen as the dark region when viewed by the human eyes; when the white particles are dispersed in the electrophoretic fluid under the action of the electric field, the white particles are uniformly displayed, and the white particles are seen as the bright region when viewed by the human eyes.

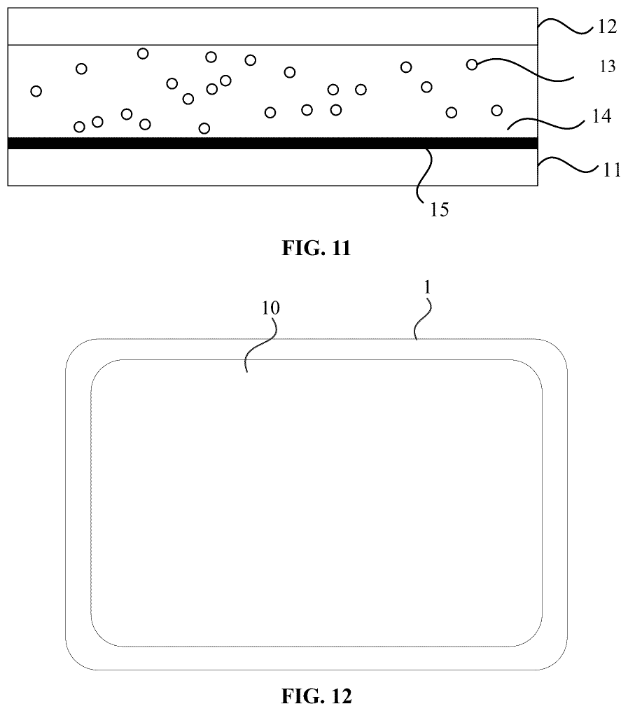

Based on the same inventive concept, an embodiment of the present disclosure further provides a display device. FIG. 12 is a top view of a display device according to an embodiment of the present disclosure. Referring to FIG. 12, the display device 1 includes the electrophoretic display panel 10 provided in the above-described embodiments. Therefore, the display device also has the beneficial effects of the electrophoretic display panel in the above-described embodiments, and the same parts may be understood with reference to the above explanation of the electrophoretic display panel, which will not be repeated hereinafter.

The display device 1 provided in this embodiment of the present disclosure may be the electronic paper shown in FIG. 12, or may be any electronic product having the display function, including but not limited to the following categories: a mobile phone, a television, a notebook computer, a desktop display, a tablet computer, a digital camera, a smart bracelet, smart glasses, a vehicle-mounted display, an industrial control device, a medical display screen, a touch interaction terminal, and the like, which is not particularly limited in the embodiments of the present disclosure.

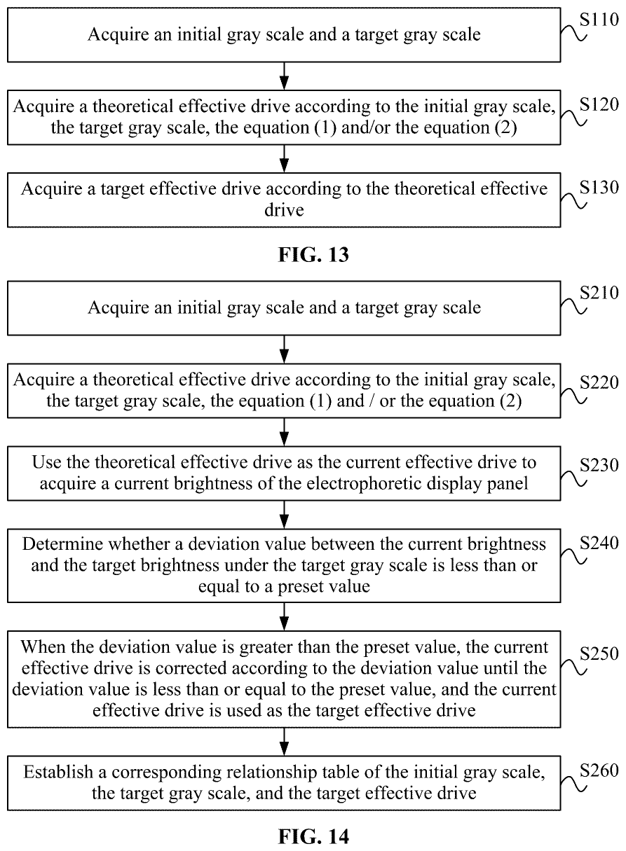

Based on the same inventive concept, an embodiment of the present disclosure further provides a driving method of an electrophoretic display panel. FIG. 13 is a flowchart of a driving method of an electrophoretic display panel according to an embodiment of the present disclosure, referring to FIG. 13, the driving method includes steps described below.

In S110, an initial gray scale and a target gray scale are acquired.

The electrophoretic display panel includes data lines and pixels, and the data line is configured to transmit the data signal to the pixel. Further, the electrophoretic display panel further includes scanning lines configured to transmit scanning signals to the pixels, and the scanning signal is a signal for controlling the thin film transistor to be turned on. When the thin film transistor is turned on, the data signal is written to the pixel. Different data signals are written into different pixels, the electrophoretic display panel may display the specific image.

The data signal Source includes multiple unit periods. The duration of the enable level of the data signal Source is an integer multiple of the unit period. In the driving stage of the electrophoretic display panel, the multiple data lines write different data signals Source for different pixels, so that different pixels may have different display brightness, and different pixels may have different gray scales. Due to the influence of different parameters on the electrophoretic display panel, the gray scale of the pixel is not linearly related to the driving duration, whereby the difficulty of adjusting the gray scale is relatively high according to the display requirement. For example, the parameter may be a temperature factor of the electrophoretic display panel and the display influence of a previous picture, which are not specifically limited in the embodiments of the present disclosure.

In the driving stage, in the i-th unit period tᵢ, the unit driving voltage of the data signal Source is Vᵢ, the target effective drive is Vₘ, and the target effective drive is expressed as Vₘ=ΣVᵢtᵢ, where i is a positive integer. The length of the i-th unit period tᵢ is equal to the length of the unit period. In one embodiment, a duration of the unit period is a duration of a scanning frame. In one scanning frame, the first scanning line is scanned row by row to the last scanning line. The unit driving voltage Vᵢ is a driving voltage after normalization processing. A voltage value of the i-th unit driving voltage Vᵢ is 1V The target effective drive Vₘ is an accumulated value representing the product of voltage and time. The target effective drive may be understood as a value of an effective drive actually applied.

The initial gray scale is a gray scale value corresponding to a current picture at the starting occasion, that is, a gray scale value corresponding to the previous picture at an ending occasion. The target gray scale is a preset gray scale value.

In S120, a theoretical effective drive is acquired according to the initial gray scale, the target gray scale, the equation (1) and/or the equation (2).

Correspondingly, referring to FIG. 4 and FIG. 5, FIG. 4 is a schematic diagram of a relationship between an initial gray scale and an effective drive according to an embodiment of the present disclosure. Referring to FIG. 4, a value of the abscissa in FIG. 4 represents the value of the initial gray scale, and a value of the ordinate in FIG. 4 represent the value of the effective drive including the target effective drive and the theoretical effective drive. FIG. 4 shows multiple discrete points, and an effective drive corresponding to the discrete points is the target effective drive. The discrete point may be understood as a point determined in the coordinate system by a value of the certain initial gray scale and a value of the certain effective drive when the target gray scale is the fixed value. Two fitting curves (s1 and s2 shown in FIG. 4) are shown in FIG. 4, where the fitting curve is an equation that the theoretical effective drive and the initial gray scale are used as variables when the target gray scale is the fixed value, and the effective drive that may be obtained by substituting the initial gray scale into the equation is the theoretical effective drive. That the difference value between the target effective drive and the theoretical effective drive is less than or equal to 5 may be understood as that values of the effective drive obtained by the fitting curve are the same as or similar to values of the actually applied target effective drive. Optionally, the difference value between the target effective drive and the theoretical effective drive is less than or equal to 2. Further, the difference value between the target effective drive and the theoretical effective drive is less than or equal to 1. In some embodiments, referring to FIG. 4, the electrophoretic display panel is under the driving of the 64 gray scales, when the target gray scale is the fixed value, when the initial gray scale is 0 (y=0), the difference value between the target effective drive and the theoretical effective drive is less than or equal to 5; when the initial gray scale is 5 to 8 (y=5, y=6, y=7 or y=8), the difference value between the target effective drive and the theoretical effective drive is less than or equal to 2; and when the initial gray scale takes other values, the difference value between the target effective drive and the theoretical effective drive is less than or equal to 1.

When the target gray scale is the fixed value, a value of a target effective drive corresponding to the initial gray scale is stored in the driving chip. In the electrophoretic display panel, a discrete value of the effective drive may be acquired by directly looking up the table in the driving chip, that is, a value of the target effective drive is obtained by directly looking up the table, further an accurate driving waveform is acquired, and then the gray scale is adjusted according to the driving waveform, whereby the speed and the accuracy of adjustment of the gray scale can be improved.

Specifically, FIG. 4 illustrates the acquisition of discrete points and the fitting of the equation of the electrophoretic display panel under the driving of the 64 gray scales. When the target gray scale is the fixed value, an equation obtained by fitting satisfies: an equation (1),

$${V}_{l} = \frac{64}{n} Ax + B ,$$

where x is the initial gray scale, y denotes the target gray scale, Vₗ denotes the theoretical effective drive, each of x and y is an integer, and n is the number of gray scales of the electrophoretic display panel in one driving mode, and where 0.23<A<0.29, and −20<B<10. In the current embodiment, n is the number of gray scales of the electrophoretic display panel in a 64 gray scale driving mode, and n is equal to 64. In other embodiments, n may take other positive integer values, values of n are not limited in the present disclosure, and n may be odd numbers or even numbers. For example, A may be 0.26. In some embodiments, a an equation obtained by fitting may be Vₗ=0.2688x+5.75 or Vₗ=0.2688x−15.375. Specific values of A and B may be adaptively adjusted according to the difference of the selected target gray scales, which is not specifically limited in the embodiments of the present disclosure. Optionally, when n is 63,

$$\frac{64}{n}$$

in

$${V}_{l} = \frac{64}{n} Ax + B$$

is a non-integer, a correction may be performed on

$$\frac{64}{n}$$

in combination with A, that is, the coefficient before the initial gray scale in the equation (1) is used as the variable is determined by

$$\frac{64}{n}$$

### and A.

For example, the significant digit may be determined according to test and fitting precision, and the numerical precision may be determined to 2 bits, 3 bits, or 4 significant digits as required. Other parameters are similar and may also be determined according to test and fitting accuracy. In some embodiments, referring to FIG. 4, two types of discrete points are shown in FIG. 4, one is a discrete point that is effectively driven by a target and obtained under different initial gray scales when the target gray scale is zero (that is). The other is a discrete point of the target effective drive obtained at different initial gray scales when the target gray scale is 63 (i.e., 63). FIG. 4 further shows a fitting relationship corresponding to different target gray scales, one fitting relationship is a fitting curve corresponding to the initial gray scale and the theoretical effective drive when the target gray scale is zero (that is) (referring to the fitting curve s1 in FIG. 4); and one fitting relationship is a fitting curve corresponding to the initial gray scale and the theoretical effective drive when the target gray scale is 63 (that is) (referring to the fitting curve s2 in FIG. 4). With reference to FIG. 4, when the target gray scale is zero, the difference between the target effective drive and the effective drive of the theoretical effective drive is small, when the initial gray scale is 0, the difference value between the target effective drive and the theoretical effective drive is equal to 5, and when the initial gray scale is 1 to 63, the difference value between the target effective drive and the theoretical effective drive is less than 5, preferably less than 2 or 1. Similarly, when the target gray scale is 63, the difference between the target effective drive and the effective drive of the theoretical effective drive is small, when the initial gray scale is 0, the difference value between the target effective drive and the theoretical effective drive is equal to 5, and when the initial gray scale is 1 to 63, the difference value between the target effective drive and the theoretical effective drive is less than 5, preferably less than 2 or 1.

As shown in FIG. 4, when the target gray scale is zero and the initial gray scale is 1 to 63, the difference value between the target effective drive and the theoretical effective drive is less than or equal to 2. When the target gray scale is 63 and the initial gray scale is 1 to 63, the difference value between the target effective drive and the theoretical effective drive is less than or equal to 2.

The fitting curve s1 represents a rule that values (i.e., discrete points near the fitting curve s1 in FIG. 4) of target effective drives are complied with when the target gray scale is zero. The fitting curve s2 represents a rule that values (i.e., discrete points near the fitting curve s2 in FIG. 4) of target effective drives are complied with when the target gray scale is 63. It is to be understood that, under the driving of the driving waveform, a gray scale test is performed on one electrophoretic display panel. According to the measured gray scale data of the electrophoretic display panel, the linear fitting is performed when the target gray scale is the fixed value, and a coefficient of a linear fitting line satisfies the range of the embodiment of the present disclosure, that is, the coefficient of the linear fitting line satisfies that a slope is greater than 0.234 or less than 0.286, an intercept is greater than −20 and less than 10, and a difference value between a value of a corresponding measured effective drive value and a value on the linear fitting line does not exceed 5.

The fitting curve s1 and the fitting curve s2 are straight lines. A slope of the fitting curve s1 and a slope of the fitting curve s2 are almost unchanged, or a slope of the fitting curve s1 changes little compared to a slope of the fitting curve s2. Although a fitting result that the target gray scale of zero and the target gray scale of 63 in the 64 gray scale driving mode is exemplarily illustrated in FIG. 4, and a fitting result that the target gray scale ranges 1 to 62 in the 64 gray scale driving mode is not illustrated in FIG. 4. It can be seen from FIG. 4 that the fitting curves with the target gray scale ranging from 1 to 62 are sequentially distributed between the fitting curve s1 and the fitting curve s2 one by one. When the value of the target gray scale changes, for example, the target gray scale changes from 0 to 63, the slope of the fitting curve is almost unchanged, and the intercept of the fitting curve changes.

FIG. 5 is a schematic diagram of a relationship between an initial gray scale and an effective drive according to an embodiment of the present disclosure. Referring to FIG. 5, a value of an abscissa in FIG. 5 represents a value of the target gray scale, a value of an ordinate in FIG. 5 represents a value of the effective drive. FIG. 5 shows multiple discrete points, an effective drive corresponding to the discrete point denotes the target effective drive. The discrete point may be understood as a point determined in the coordinate system by a value of a certain target gray scale and a value of a certain effective drive value when the initial gray scale is a fixed value. Two fitting curves (s3 and s4 shown in FIG. 5) are shown in FIG. 5, where the fitting curve denotes an equation that the theoretical effective drive and the target gray scale are used as variables when the initial gray scale is the fixed value, and an effective drive that may be obtained by substituting the target gray scale into the equation denotes the theoretical effective drive. The difference value between the target effective drive and the theoretical effective drive being less than or equal to 5 may be understood as that values of the effective drive obtained by the fitting curve are the same as or similar to values of the actually applied target effective drive. In some embodiments, referring to FIG. 5, the electrophoretic display panel is under the driving of the 64 gray scales, when the target gray scale is the fixed value and the target gray scale is 0 (x=0), the difference value between the target effective drive and the theoretical effective drive is less than or equal to 5; when the target gray scale is 5 (x=5), the difference value between the target effective drive and the theoretical effective drive is less than or equal to 2; and when the target gray scale takes other value, the difference value between the target effective drive and the theoretical effective drive is less than or equal to 1.

When the initial gray scale is the fixed value, a value of a target effective drive corresponding to the target gray scale is stored in the driving chip. In the electrophoretic display panel, a discrete value of the effective drive may be acquired by directly looking up the table in the driving chip, that is, a value of the target effective drive is obtained by directly looking up the table, further an accurate driving waveform is acquired, and then the gray scale is adjusted according to the driving waveform, whereby the speed and the accuracy of adjustment of the gray scale can be improved.

Specifically, FIG. 5 illustrates the acquisition of discrete points and the fitting of the equation of the electrophoretic display panel under the driving of the 64 gray scales. When the target gray scale is the fixed value, an equation obtained by fitting satisfies: an equation (2),

$${V}_{l} = \frac{64}{n} Cy + D ,$$

where x is the initial gray scale, y denotes the target gray scale, Vₗ denotes the theoretical effective drive, each of x and y denotes an integer, and n is the number of gray scales of the electrophoretic display panel in one driving mode, and where −0.22<C<−0.10 and 0<D<25. For example, C may be −0.18, in some embodiments, an equation obtained by fitting may be Vₗ=−0.2007x+13.022 or Vₗ=−0.1658x+11.037. The specific value of C and D may be adaptively adjusted according to the difference of the selected initial gray scales, which is not specifically limited in the embodiment of the present disclosure.

Optionally, when n is 63,

$$\frac{64}{n}$$

in

$${V}_{l} = \frac{64}{n} Cy + D$$

is a non-integer, a correction may be performed on

$$\frac{64}{n}$$

in combination with C, that is, the coefficient before the target gray scale in the equation (2) is used as the variable is determined by

$$\frac{64}{n}$$

### and A.

In some embodiments, −0.216<C<−0.14, the significant digit of C may be determined according to the test and the fitting precision, and the numerical precision of C may be determined to 2 bits, 3 bits, or 4 bits significant digits as required.

In some embodiments, referring to FIG. 5, two types of coordinate points are shown in FIG. 5. One type of coordinate point is a discrete point of a target effective drive obtained under different target gray scales when the initial gray scale is zero (i.e., x=0). The other type of coordinate point is a discrete point of a target effective drive obtained under different target gray scales when the initial gray scale is 63 (i.e., x=63). FIG. 5 further shows fitting relationships corresponding to different target gray scales, one fitting relationship is a fitting curve (referring to the fitting curve s3 in FIG. 5) corresponding to the target gray scale and the theoretical effective drive when the initial gray scale is zero (i.e., x=0); and one fitting relationship is a fitting curve (referring to the fitting curve s4 in FIG. 5) corresponding to the target gray scale and the theoretical effective drive when the initial gray scale is 63 (that is, x=63). With reference to FIG. 5, when the initial gray scale is zero, a difference value of effective drives between the target effective drive and the theoretical effective drive is relatively small, when the target gray scale is 0, the difference value between the target effective drive and the theoretical effective drive is equal to 5, and when the target gray scale ranges from 1 to 63, the difference value between the target effective drive and the theoretical effective drive is less than 5, preferably less than 2 or 1. Similarly, when the initial gray scale is 63, a difference value of effective drives between the target effective drive and the theoretical effective drive is relatively small, when the target gray scale is 0, the difference value between the target effective drive and the theoretical effective drive is equal to 5, and when the target gray scale ranges from 1 to 63, the difference value between the target effective drive and the theoretical effective drive is less than 5, preferably less than 2 or 1.

As shown in FIG. 5, when the initial gray scale is zero and the target gray scale ranges from 1 to 63, the difference value between the target effective drive and the theoretical effective drive is less than or equal to 2. When the initial gray scale is 63 and the target gray scale ranges from 1 to 63, the difference value between the target effective drive and the theoretical effective drive is less than or equal to 2.

The fitting curve s3 represents a rule that values (i.e., discrete points near the fitting curve s3 in FIG. 5) of target effective drives are complied with when the initial gray scale is zero. The fitting curve s4 represents a rule that values (i.e., discrete points near the fitting curve s4 in FIG. 5) of the target effective drives are complied with when the initial gray scale is 63. It is to be understood that, under the driving of the driving waveform, a gray scale test is performed on one electrophoretic display panel. According to the measured gray scale data of the electrophoretic display panel, the linear fitting is performed when the initial gray scale is the fixed value, and a coefficient of a linear fitting line satisfies the range of the embodiments of the present disclosure, that is, the coefficient of the linear fitting line satisfies that a slope is greater than −0.216 or less than −0.144, an intercept is greater than 0 and less than 25, and a difference value between a value of a corresponding measured effective drive value and a value on the linear fitting line does not exceed 5.

The fitting curve s3 and the fitting curve s4 are straight lines. A slope of the fitting curve s3 and a slope of the fitting curve s4 are almost unchanged, or a slope of the fitting curve s3 changes little compared to a slope of the fitting curve s4. Although a fitting result that the initial gray scale of zero and the initial gray scale of 63 in the 64 gray scale driving mode is exemplarily illustrated in FIG. 5, and a fitting result that the initial gray scale ranges from 1 to 62 in the 64 gray scale driving mode is not illustrated in FIG. 5. It can be seen from FIG. 5 that fitting curves with the initial gray scale ranging from 1 to 62 are sequentially distributed between the fitting curve s3 and the fitting curve s4 one by one. When the value of the initial gray scale changes, for example, the initial gray scale changes from 0 to 63, the slope of the fitting curve is almost unchanged, and the intercept of the fitting curve changes.

In S130, a target effective drive is acquired according to the theoretical effective drive.

The difference value between the target effective drive and the theoretical effective drive is relatively small, so that the theoretical effective drive for determining the driving waveform is relatively accurate, and the driving waveform is accurate and reliable.

In the electrophoretic display panel provided in the embodiments of the present disclosure, the theoretical effective drive satisfies the equation (1) and/or the equation (2), the difference value between the target effective drive and the theoretical effective drive is relatively small, and the rule satisfied by each numerical point of the target effective drive may be described by using the equation satisfied by the theoretical effective drive. The driving waveform determined according to the target effective drive is relatively accurate. Moreover, during debugging, a value of the theoretical effective drive is obtained according to the equation (1) and/or the equation (2), a test is performed near the value of the theoretical effective drive based on the value of the theoretical effective drive, and a suitable value of the effective drive is found as the target effective drive. Compared with blind debugging without any basis, the speed and accuracy of adjustment of the gray scale are improved, and thus the calibration difficulty of the gray scale in the process of testing the electrophoretic display panel can be reduced.

It is to be noted that the initial gray scale x, the target gray scale y, and the theoretical effective drive Vₗ may constitute a ternary equation, the initial gray scale x and the target gray scale y are variables, and the value obtained by the theoretical effective drive Vₗ according to the two variables has a larger error than a value obtained by the theoretical effective drive Vₗ according to one variable by fixing one of the initial gray level x and the target gray level y. Therefore, in the embodiments of the present invention, the target gray scale y is fixed, so that the theoretical effective drive Vₗ satisfies the equation (1); and/or the initial gray scale x is fixed, so that the theoretical effective drive Vₗ satisfies the equation (2).

FIG. 14 is a flowchart of another driving method of an electrophoretic display panel according to an embodiment of the present disclosure. Referring to FIG. 14, the driving method includes steps described below.

In S210, an initial gray scale and a target gray scale are acquired.

In S220, a theoretical effective drive is acquired according to the initial gray scale, the target gray scale, the equation (1) and/or the equation (2).

In S230, the theoretical effective drive is used as the current effective drive to acquire a current brightness of the electrophoretic display panel.

When the target gray scale is the fixed value, an equation obtained by the fitting satisfies the equation (1), i.e.,

$${V}_{l} = \frac{64}{n} Ax + B ,$$

where x is the initial gray scale, y denotes the target gray scale, Vₗ denotes the theoretical effective drive; when the target gray scale is the fixed value, an equation obtained by the fitting satisfies the equation (2), i.e.,

$${V}_{l} = \frac{64}{n} Cy + D .$$

The effective drive obtained by the equation (1) and/or the equation (2) is the theoretical effective drive. In the test process, the electrophoretic display panel is driven by driving the driving waveform corresponding to the theoretical effective drive, thereby acquiring the current brightness of the electrophoretic display panel.

In S240, whether a deviation value between the current brightness and the target brightness under the target gray scale is less than or equal to a preset value is determined.

Further, a deviation value between the current brightness and the target brightness under the target gray scale may be understood as determining a difference value between the theoretical effective drive and the target effective drive. The preset value may be set differently according to different electrophoretic display panels.

In S250, when the deviation value is greater than the preset value, the current effective drive is corrected according to the deviation value until the deviation value is less than or equal to the preset value, and the current effective drive is used as the target effective drive.

When the deviation value is greater than the preset value, it is proved that the difference value between the theoretical effective drive obtained through the equation and the target effective drive is relatively large, and the current effective drive may be corrected according to the deviation value, that is, the theoretical effective drive is corrected, so that it is ensured that the difference value between the target effective drive and the theoretical effective drive is relatively small; therefore, the theoretical effective drive for determining the driving waveform is relatively accurate, and thus the driving waveform is accurate and reliable.

After the current effective drive is corrected according to the deviation value, the deviation value is continuously compared with the preset value, and if the deviation value is further greater than the preset value, the current effective drive is continuously corrected according to the deviation value; and if the deviation value is less than or equal to the preset value, the current effective drive is used as the target effective drive, it is ensured that the difference value between the target effective drive and the theoretical effective drive is relatively small, and the theoretical effective drive used for determining the driving waveform is relatively accurate. The electrophoretic display panel adjusts the gray scale according to the driving waveform, so that the speed and accuracy of the adjustment of the gray scale are improved, and the calibration difficulty of the gray scale in the test process of the electrophoretic display panel can be reduced.

In S260, a corresponding relationship table of the initial gray scale, the target gray scale, and the target effective drive is established.

The corresponding relationship table is established by a corresponding relationship among the initial gray scale, the target gray scale and the target effective drive, and the relationship table is stored at the driving chip. In the electrophoretic display panel, a discrete value of the effective drive may be acquired by directly looking up the table in the driving chip, that is, a value of the target effective drive is obtained by directly looking up the table, further an accurate driving waveform is acquired, and then the gray scale is adjusted according to the driving waveform, whereby the speed and the accuracy of adjustment of the gray scale can be improved.

It is to be noted that the above contents are merely preferred embodiments of the present disclosure and the technical principles applied herein. It is to be understood by those skilled in the art that the present disclosure is not limited to the particular embodiments described herein. For those skilled in the art, various apparent modifications, adaptations, combinations and substitutions may be made without departing from the scope of the present disclosure. Therefore, although the present disclosure has been described in detail through the above embodiments, the present disclosure is not limited to the above embodiments and may include more other equivalent embodiments without departing from the concept of the present disclosure. The scope of the present disclosure is determined by the scope of the appended claims.

What is claimed is:

1. An electrophoretic display panel, comprising data lines and pixels, wherein the data lines are configured to transmit data signals to the pixels, and a data signal comprises a plurality of unit periods;
in a driving stage of the electrophoretic display panel, in an i-th unit period tᵢ among the plurality of unit periods, a unit driving voltage of the data signal is Vᵢ, a target effective drive is Vₘ, and Vₘ=ΣVᵢtᵢ is satisfied, wherein i is a positive integer;
a theoretical effective drive satisfies at least one of following equations:
in an equation (1), when a target gray scale is fixed,
$${V}_{l} = \frac{64}{n} Ax + B ;$$
wherein x denotes an initial gray scale, y denotes the target gray scale, Vₗ denotes the theoretical effective drive, each of x and y is an integer, and n is a number of gray scales of the electrophoretic display panel in one driving mode, and wherein 0.23<A<0.29, −20<B<10;
in an equation (2), when the initial gray scale is fixed,
$${V}_{l} = \frac{64}{n} Cy + D ;$$
wherein −0.22<C<−0.10, 0<D<25; and
a difference value between the target effective drive and the theoretical effective drive is less than or equal to 5.

2. The electrophoretic display panel of claim 1, wherein 0.24<A<0.28.

3. The electrophoretic display panel of claim 2, wherein under the driving of 64 gray scales, when y=0, Vₗ=0.2688x+B, and wherein 0.75≤B<10; and/or
under the driving of the 64 gray scales, when y=63, Vₗ=0.2798x+B, wherein −20<B≤−10.581.

4. The electrophoretic display panel of claim 1, wherein under the driving of 64 gray scales, when x=0, Vₗ=−0.2007y+13.022; and/or
under the driving of the 64 gray scales, when x=63, Vₗ=−0.1658y+11.037.

5. The electrophoretic display panel of claim 1, wherein under the driving of 16 gray scales, when the target gray scale is fixed, Vₗ=Ex+F, and wherein 0.99<E<1.21, and −20<F<10.

6. The electrophoretic display panel of claim 5, wherein 1.0<E<1.2.

7. The electrophoretic display panel of claim 1, wherein under the driving of 16 gray scales, when the initial gray scale is fixed, Vₗ=Gy+H; and
wherein −0.9<G<−0.6, and 0<H<25.

8. The electrophoretic display panel of claim 7, wherein under the driving of the 16 gray scales, when x=0, Vₗ=−0.6632y+11.037; and/or
under the driving of the 16 gray scales, when x=15, Vₗ=−0.8029y+13.022.

9. The electrophoretic display panel of claim 1, wherein a value of Vᵢ in the i-th unit period tᵢ among the plurality of unit periods is 0, 1 or −1, the unit of Vᵢ is V0, and V0 is a constant voltage.

10. The electrophoretic display panel of claim 1, wherein the driving stage of the electrophoretic display panel comprises a writing stage and an activation stage, and the activation stage is before the writing stage; and
the activation stage comprises at least two sub-activation stages, and polarities of a driving voltage of the data signal in the at least two sub-activation stages are opposite to each other.

11. The electrophoretic display panel of claim 10, wherein the at least two sub-activation stages comprise a first sub-activation stage and a second sub-activation stage, and a driving voltage of the data signal in the first sub-activation stage is equal in value but opposite in direction to a driving voltage of the data signal in the second sub-activation stage;
a duration of the first sub-activation stage is equal to a duration of the second sub-activation stage.

12. The electrophoretic display panel of claim 10, wherein the at least two sub-activation stages comprise a first sub-activation stage and a second sub-activation stage, a driving voltage of the data signal in the first sub-activation stage is equal in value but opposite in direction to a driving voltage of the data signal in the second sub-activation stage, the second sub-activation stage is located between the first sub-activation stage and the writing stage, and a polarity of a voltage in the second sub-activation stage is the same as a polarity of a voltage in the writing stage; and
in the writing stage, the data signal comprises a write driving signal and a direct current (DC) balance signal, a duration of the second sub-activation stage minus a duration of the first sub-activation stage equals to a duration difference value, and a duration of the DC balance signal is equal to the duration difference value.

13. The electrophoretic display panel of claim 1, further comprising a first substrate, an electrophoretic fluid and a plurality of electrophoretic particles;
wherein the data lines and the pixels are located on a same side of the first substrate facing the plurality of electrophoretic particles; and
the plurality of electrophoretic particles are charged particles doped in the electrophoretic fluid.

14. The electrophoretic display panel of claim 13, wherein the plurality of electrophoretic particles comprise a first electrophoretic particle and a second electrophoretic particle, and a color of the first electrophoretic particle is different form a color of the second electrophoretic particle.

15. The electrophoretic display panel of claim 13, wherein a color of the electrophoretic fluid is different from a color of each of the plurality of electrophoretic particles.

16. The electrophoretic display panel of claim 1, wherein a difference value between the target effective drive and the theoretical effective drive is less than or equal to 2.

17. A display device, comprising the electrophoretic display panel of claim 1 and a driving chip, wherein the driving chip provides the data signal to the data lines.

18. A driving method based on the electrophoretic display panel of claim 1, comprising:
acquiring an initial gray scale and a target gray scale;
acquiring a theoretical effective drive according to the initial gray scale, the target gray scale, the equation (1) and/or the equation (2); and
acquiring a target effective drive according to the theoretical effective drive.

19. The driving method of claim 18, wherein acquiring the target effective drive according to the theoretical effective drive comprises:
acquiring a current brightness of the electrophoretic display panel by using the theoretical effective drive as a current effective drive;
determining whether a deviation value between the current brightness and a target brightness under the target gray scale is less than or equal to a preset value; and
when the deviation value is greater than the preset value, correcting, according to the deviation value, the current effective drive until the deviation value is less than or equal to the preset value, and using the current effective drive as the target effective drive.

20. The driving method of claim 18, wherein after acquiring the target effective drive according to the theoretical effective drive, the method further comprises:
establishing a corresponding relationship table of the initial gray scale, the target gray scale, and the target effective drive.
